(19) United States
(12) Patent Application Publication
(10) Pub. No.: US 2005/0144093 A1
(43) Pub. Date: Jun. 30, 2005

(54) E-commerce shopping

(76) Inventor: Peter Kassan, Dobbs Ferry, NY (US)

Correspondence Address: OSTROLENK FABER GERB & SOFFEN, 1180 AVENUE OF THE AMERICAS, NEW YORK, NY, 100368403, US

(21) Appl. No.: 10/842,945

(22) Filed: May 10, 2004

Related U.S. Application Data
(60) Provisional application No. 60/532,980, filed on Dec. 29, 2003.

(51) Int. Cl. G06F 17/60

(52) U.S. Cl. 705/27

(57) ABSTRACT

The invention provides a user interface for selecting at least one good or service for purchase in an e-commerce site. The user interface comprises a first electronic representation of a good or service offered for sale on the e-commerce site, an electronic shopping cart adapted to contain at least a second representation of the goods or services offered for sale on the e-commerce site, and an icon associated with the electronic representation that, when selected, causes the second representation of the at least one good or service to be placed in an electronic shopping cart, wherein the icon includes no text and wherein the icon is placed in a position relative to the first representation.

### CROSS-REFERENCE TO RELATED APPLICATIONS

The present invention is based on and claims priority to U.S. Provisional Patent Application Ser. No. 60/532,980, filed Dec. 29, 2003 entitled “IMPROVEMENTS TO E-COMMERCE SYSTEMS AND PROCESSES,” the entire contents of which are incorporated by reference.

### FIELD OF THE INVENTION

The present invention relates to Internet e-commerce web sites, and, more particularly, to ensuring that a visitor to an e-commerce web site completes a sales transaction.

### BACKGROUND OF THE INVENTION

As the number of people with access to the Internet and the worldwide web continues to increase, the number of sales of goods and services via Internet-related e-commerce web sites likewise continues to rise. Internet-related e-commerce web sites typically provide mechanisms that enable visitors to browse virtual representations of goods and services, and to place an order and electronically pay for the goods and services being offered. Every year the number of on-line sales rises and this trend is not expected to change.

In spite of the proliferation of Internet-related e-commerce web sites, the systems and methods provided in prior art e-commerce web sites have shortcomings. For example, due to the way that purchasing mechanisms are provided, visitors to Internet-related e-commerce web sites encounter inconvenient and time consuming purchasing methods that increase the likelihood of a sales transaction being interrupted and/or abandoned. Thus, due to the way prior art Internet-related e-commerce web sites are structured, an on-line purchaser cannot conveniently browse an item and, thereafter, purchase the item.

Furthermore, messages, such as instructional text, that appear on an Internet-related e-commerce web site are typically static and do not provide a dynamic, personal and interactive content during an on-line shopping session. Moreover, such instructional text often crowds the layout of Internet-related e-commerce web sites and often confuses the on-line shopper. These and other shortcomings of Internet-related e-commerce web sites increase the likelihood that an on-line purchaser will terminate the session prior to completing a sales transaction.

Many users of computing devices prefer to size windowed portions within a display screen. Various portions of a display screen, for example, a web browser software application displayed in a window, can be resized. Typically, windowed portions of a display screen are resized by selecting a graphic control. For example, single clicking the “Restore Window” control, selecting the control box and selecting “Restore”, or by double-clicking the title bar portion of a web browser display screen, results in the windowed portion being resized. One observed shortcoming of prior art Internet-related e-commerce web sites regards the relative placement of icons. In prior art e-commerce web sites, the position of icons is affected by resizing windowed portion of a display screen. Graphic icons that accompany or are accompanied by descriptive text often appear disjointed and/or unrelated due to the position of the icons/text after a window is resized. The result is a confusing interface that can result in a loss of potential revenue.

An examination of the fifty most commonly visited e-commerce web sites, according to www.alexa.com, reveals that, for those web sites that use e-shopping carts (also referred to as “shopping baskets,” “shopping bags” or the like), certain processes associated with the placement of items into e-shopping carts (i.e., items to be purchased) include one or more of the following shortcomings. In a typical prior art Internet-related e-commerce web site, in order to add an item to an e-shopping cart, a visitor selects a hyperlink that is physically distinct and separated from the representation, typically an image such as a Joint Photographic Experts Group (JPEG) image, of the item intended to be added to the shopping cart. For example, a hyperlink that states “Put in Shopping Cart” is visually separate from the representation of the item by some physical distance, and often filled with the background color of that portion of the visual display.

Referring to the drawing figures, in which like reference numerals refer to like elements, there is shown in FIGS. 1-30 examples of typical, prior art Internet-related e-commerce web sites that illustrate the above-described shortcomings. In the example shown in FIG. 1, the “Add to Shopping Cart” hyperlink 102 appears in the upper right-hand corner of the display, a substantial distance from the depiction of the item. Occasionally, as shown in FIG. 2, hyperlink 102 is not formatted with any phrase instructing a user to select the hyperlink to add the item to a shopping cart. Such lack of clear instructional text does not provide any indication that the icon is formatted as a hyperlink at all.

In typical prior art Internet-related e-commerce web sites, such as shown in FIGS. 1 and 2, hyperlink 102 for adding items to an e-commerce shopping cart contains instructional text 104, such as “put in shopping cart”, “put in cart”, “put in shopping bag”, “put in shopping basket”, “buy me”, “buy this item now!”, “buy online”, “purchase”, “add to shopping cart”, “add” or the like. In some cases, instructional text 104 is formatted different from the rest of the web site. For example, in the example web site shown in FIG. 3, instructional text 104, “Get this DVD now!” is formatted in a different color from the rest of the web page. Such formatting of instructional text 104 causes confusion for the viewer.

When a user places a graphic selector (i.e., moves the mouse) over an icon that is formatted as a hyperlink, in a typical prior art Internet-related e-commerce web page, text (known in the art as “flyover text”) appears. In a typical prior art Internet-related e-commerce web site, flyover text does not change according to various contexts vis a vis the visitor's actions. For example, prior art flyover text does not identify the number of items a user has selected for purchase during a particular shopping session. Instead, flyover text typically reiterates or paraphrases text that appears on or near the icon itself, and also is static. In the example e-commerce Internet web site shown in FIG. 4, the result of placing the mouse pointer on or very near the icon labeled “Add to cart” displays the flyover text, “ADD TO CART.” After a user purchases the item, the flyover text does not change when the user moves the mouse selector over the same icon.

Many items offered for sale in Internet-related e-commerce web sites are available in various sizes, colors, models, and the like. In such prior art web sites, each of the above variations must be specified by the purchaser prior to or while adding the item to the e-shopping cart. In the example prior art e-commerce web sites shown in FIGS. 5 and 6, drop-down list 502 enables the user to specify the color and size of Chain Belt Jeans. Warning label 602 (FIG. 6) is presented to the purchaser who has attempted to add the Jeans to an e-shopping cart (labeled as a “bag”) without first specifying the color and size of the Jeans.

In addition to styles and colors, prior art Internet-related e-commerce web sites require the visitor to select the quantity of an item before placing the item in an e-shopping basket. In the example e-commerce web page shown in FIG. 7, the quantity value 702 is set to zero by default. Even though choices for size and color have valid default values, since quantity value 702 equals zero, the process of selecting the hyperlink “Add to shopping bag” 102 does not result in an item being added to an e-commerce shopping cart, for example, as shown in FIG. 8.

Furthermore, purchase specifications, such as product size, color or the like, received in prior art Internet-related e-commerce web sites are not stored for use in future on-line shopping sessions. Thus, the visitor must repeatedly specify purchase specifications with the same e-commerce web site even during a single on-line shopping session. For example, the example prior art e-commerce web sites shown in FIGS. 9, 10 and 11 illustrate a sequence of steps for specifying an item size and placing the item in an e-shopping cart. The example prior art e-commerce web site shown in FIG. 12 illustrates that, in a single shopping session, a purchaser must re-specify the size for each additional item placed in the e-shopping cart.

In cases in which the quantity value 702 is initially set by default, typically to equal 1, (as shown in FIG. 13), selecting the choice “Add to shopping bag” results in error message 1402 being displayed if the default value is removed (FIG. 14). Error message 1402 appears because one or more purchase options, including quantity value 702, was not specified prior to placing the item in the e-shopping cart.

User interfaces provided in prior art Internet-related e-commerce web sites, and particularly with respect to the home page or a related page (such as the first page of a major product category), is, typically, not conducive for easy on-line purchasing. Typically, a purchaser must navigate through several web site display screens before accessing the particular display screen in which an item can be added to an e-commerce shopping cart and purchased. For example, FIG. 15 shows the home page of the e-commerce web site provided by BEST BUY (www.bestbuy.com). Although several items are depicted and offered for sale, no control or mechanism is provided that enables a purchaser to place the items into an e-commerce shopping cart. Instead, a purchaser must select hyperlink 1502, representing an item for sale, in order to access another web page which provides additional details about the item (FIG. 16). In the example shown in FIG. 16, the visitor must make another selection (hyperlink 102) to add the item to an e-shopping cart. Lower level web pages that typify steps associated with on-line purchasing only include some of the items that may be directly selectable (shown for example, in FIGS. 17 and 18).

Some prior art Internet-related e-commerce Internet web sites include an option for specifying various preferences for items that are intended for more than one recipient. Typically, however, particular preferences representing each recipient are not stored and recalled for future use. For example, FIGS. 19-30 show a series of prior art e-commerce Internet web site display screens provided by the retail store, GAP, for purchasing clothing. In the example e-commerce Internet web site shown in FIG. 19, Ship-To drop-down list 1902 is provided for identifying a “Ship To” location. FIG. 20 shows that “me” is specified by default, with the ability to specify “someone else.” The example e-commerce web page, shown in FIG. 21, is displayed in case the value “someone else” is specified from the drop-down list shown in FIG. 20. As shown in FIG. 21, text box 2102 is provided for a visitor to submit a one-word name for the receiving party. FIG. 22 shows the name being specified, and FIG. 23 shows the result. FIGS. 24 and 25 illustrate the process of adding an item for a second recipient (“me”). FIGS. 26 and 27 illustrate the above-described shortcoming in the prior art in that the size must be re-specified, even after the recipient has been previously identified.

Continuing with the example e-commerce shopping session illustrated in FIGS. 19-30, in case no items have been selected for a particular recipient, then, for example, no ability is provided to store the name of the recipient and associated preferences for future use.

FIGS. 28 and 29 illustrate example steps associated with the process of removing an item from the list of items intended for a single recipient, i.e., Thomas. Once there are no longer any items intended for that recipient, the recipient is no longer available in the “ship to” list, as shown in FIG. 30. Furthermore, as illustrated in FIG. 28, there is no convenient way to specify different shipping options for each recipient while reviewing contents of an e-shopping cart.

Another shortcoming associated with prior art Internet-related e-commerce web pages relates to once a sales transaction is complete. At that point, there are no longer any items in the shopping cart and the names and characteristics of the intended recipients regarding the completed transaction are not stored for use. Thus, the names and characteristics have to be resubmitted during future purchasing sessions.

Prior art Internet-related e-commerce web sites in which the contents of an e-shopping cart are not displayed on the particular web page in which visitors select items, requires navigation between the shopping pages and the shopping cart display and is awkward and often confusing. In some cases, as soon as an item is placed in an e-shopping cart, the user is provided with a display of the shopping cart page. If the user clicks on a hyperlink to continue shopping, the display often is switched to an illogical or unexpected place, such as the home page or the main shopping page, rather than the most recently visited selection page. Alternatively, other prior art Internet-related e-commerce web sites that do not display shopping cart contents on all or most of the shopping pages, in case the shopping cart page is not automatically displayed, the user does not receive sufficient feedback that the item has been successfully placed in the shopping cart. This may place the same item in the shopping cart several times.

The above describes various shortcomings with respect to prior art Internet e-commerce web sites. Overcoming such shortcomings remains a major issue. Also, as has been repeatedly shown, users of prior Internet e-commerce web sites are burdened with excessive mouse movements and clicks to accomplish a task that, ideally, should be very easy to perform. Thus, the number of completed sales transactions decreases as a result.

### SUMMARY OF THE INVENTION

The present invention addresses all of these difficulties, reduces the actions required of the user to place an item in a shopping cart, reduces the distance necessary to move the mouse pointer to place an item in a shopping cart, and allows the user to place an item in a shopping cart without fully specifying the variation desired of the item.

More particularly, the present invention provides a user interface for selecting at least one good or service for purchase in an e-commerce site. The interface includes a first electronic representation of a good or service offered for sale on the e-commerce site, an electronic shopping cart adapted to contain at least a second representation of the good or service, and an icon associated with the electronic representation that, when selected, causes the second representation of the at least one good or service to be placed in an electronic shopping cart, wherein the icon includes no text and wherein the icon is placed in a predetermined position relative to the first representation.

Further, the icon in the user interface completely overlaps with the first representation. In an example embodiment of the present invention, the icon is placed adjacent to the first representation of the good or service. Alternatively, the icon intersects a portion of the first representation of the good or service. The icon provided in the interface may include various representations. For example, the icon can be formatted to represent a shopping cart. Alternatively, the icon includes a representation of the good or service.

In another example embodiment of the present invention, the icon changes to include a quantity of the good or service requested for purchase when a selector is placed at least near the icon. The changed icon preferably includes information regarding details of the good or service. Also, the interface preferably provides dynamically changing flyover text that is associated with the icon. Further, the flyover text includes a description of the good or service

### BRIEF DESCRIPTION OF THE DRAWINGS

For the purposes of illustrating the invention, there is shown in the drawings a form which is presently preferred, it being understood however, that the invention is not limited to the precise arrangements and instrumentalities shown. The features and advantages of the present invention will become apparent from the following description of the invention that refers to the accompanying drawings, in which:

FIGS. 1-30 illustrates a typical, prior art Internet e-commerce web site;

FIGS. 31-45 illustrate example embodiments of the present invention.

### DETAILED DESCRIPTION OF THE PREFERRED EMBODIMENTS OF THE INVENTION

The present invention is directed to reducing requirements of a visitor to an Internet-related e-commerce web site with respect to making an on-line purchase. The invention improves prior art e-commerce interfaces that are cumbersome and confusing for potential purchasers.

As used herein, the term “e-shopping cart” or “shopping cart” refers to, generally, an electronic place holder that indicates selections made in an Internet-related e-commerce web page of goods and/or services for purchase. E-shopping carts, typically used in e-commerce web sites, are known to those skilled in the art.

Also as used herein, an Internet-related e-commerce web site (or Internet-related e-commerce web page) refers, generally, to an interface enabling business communication and/or transactions over a publicly accessible communication network such as the Internet. As known to those skilled in the art, buying and selling of goods and/or services, and the transfer of funds occurs via digital communications are typical applications of an e-commerce web site. Internet-related e-commerce web sites provide mechanisms for buying and selling over the worldwide web. An Internet-related e-commerce web page typically includes a mechanism that allows a visitor to complete a sales transaction, for example, by submitting a credit card number, debit card number or the like.

As used herein, a “visitor” refers, generally, to a user operating a web-enabled user terminal and who has engaged in, is engaged in, or will engage in an “on-line” communication session (referred herein, generally, as a “visit”), typically via standard web browser software, with an HTTP server included in providing an e-commerce web site. Also as used herein, the term, “module,” refers, generally, to one or more discrete components that contribute to the effectiveness of the present invention. Modules can include software elements, including but not limited to functions, algorithms, objects and the like. Modules can also include hardware elements, substantially for performing the steps or contributing to the performance of steps associated with the present invention. Modules can operate independently or, alternatively, can depend upon one or more other modules in order to function.

In accordance with an example embodiment of the present invention, a small icon, such as a representation of a shopping basket, bag, cart, or the like, is provided with no accompanying text. The lack of text accompanying the icon allows the icon to be smaller, thereby requiring much less valuable space in the display screen.

FIGS. 31-45 illustrate example embodiments of the present invention. The embodiments shown in FIGS. 31-45 illustrate an example icon 3102 that is formatted to represent a shopping cart. The embodiments shown in FIGS. 31-45 are not meant to limit or restrict the present invention to only icons representing shopping carts. The present invention envisions use of any icon that relates to adding items to an e-shopping cart. Such icons can be formatted in many ways and are included in the present invention and function as icon 3102.

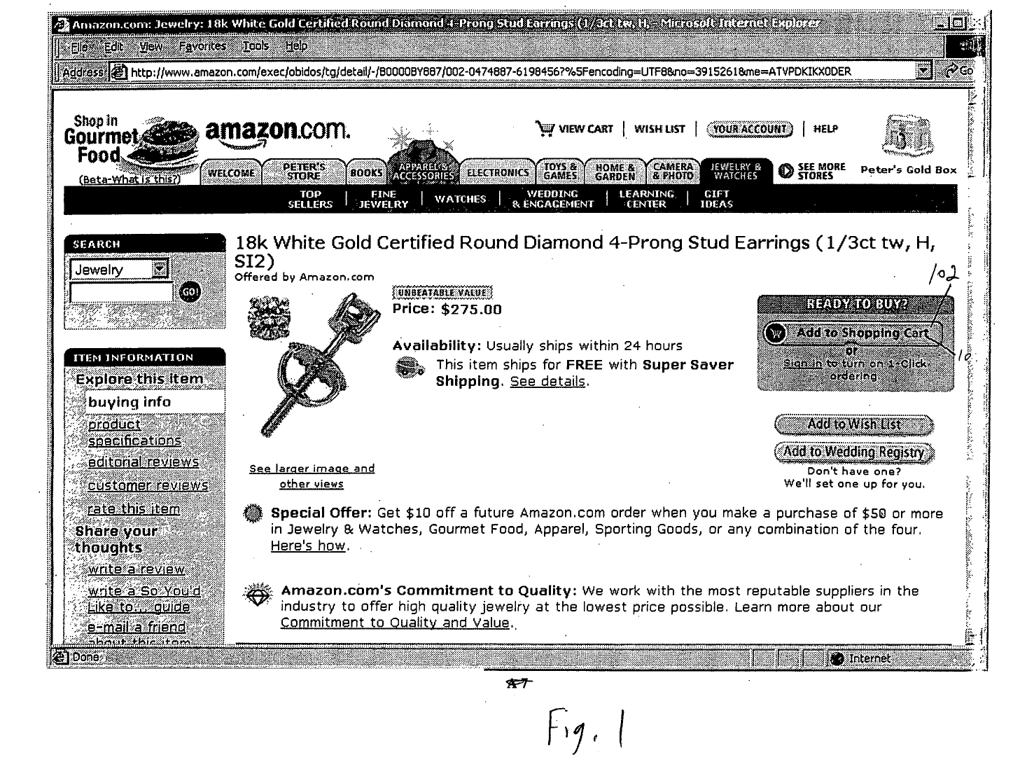

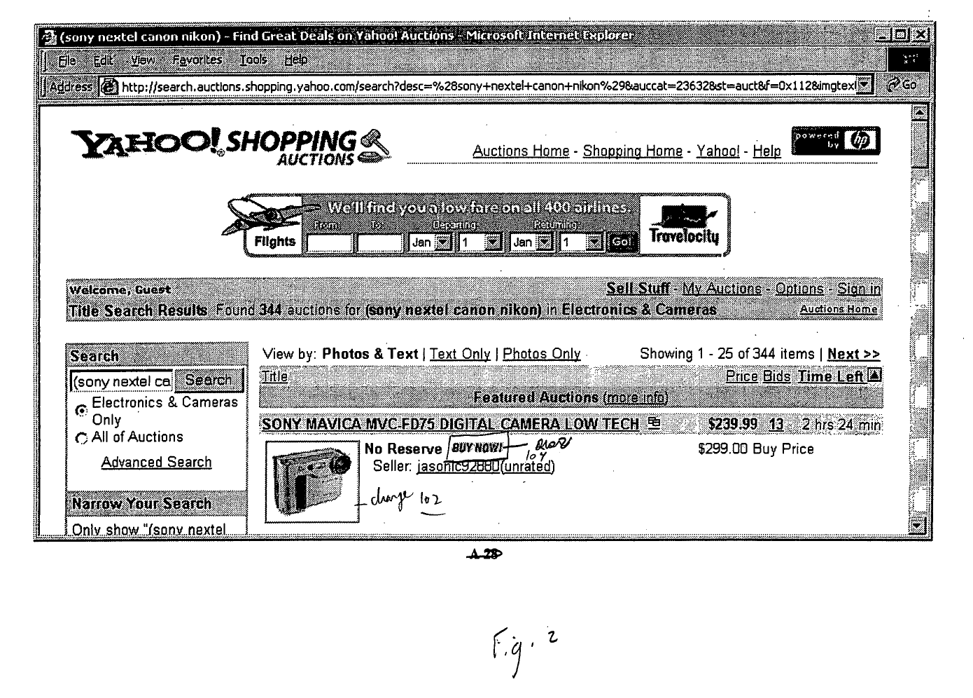

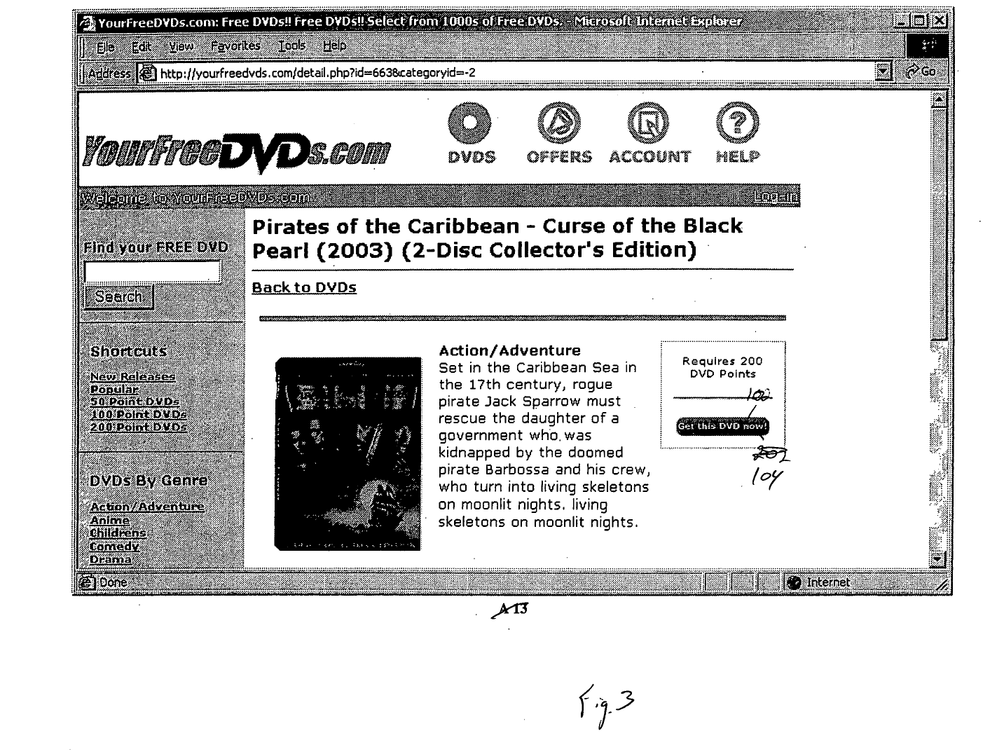

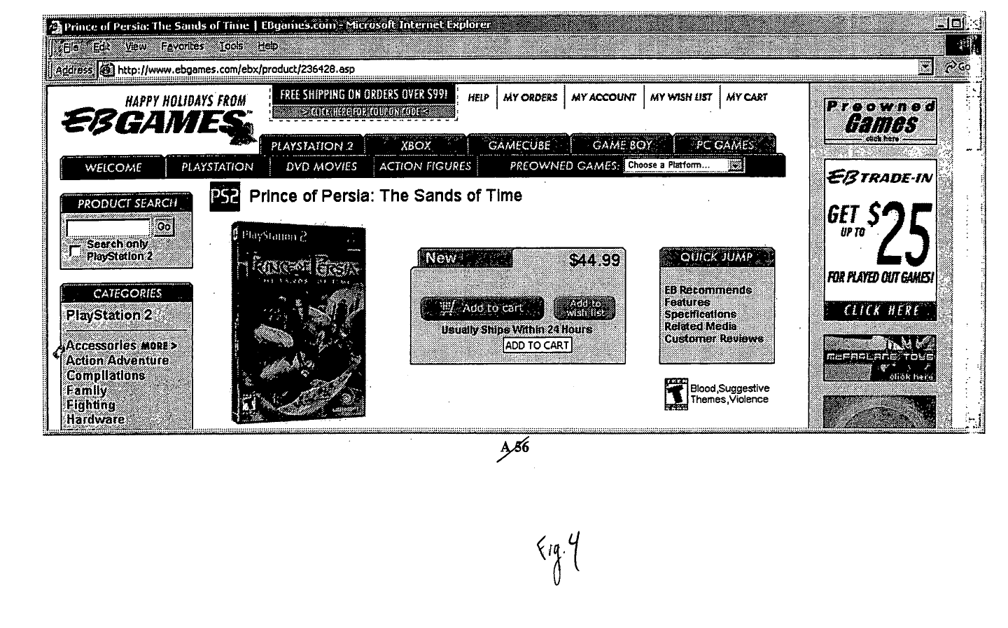

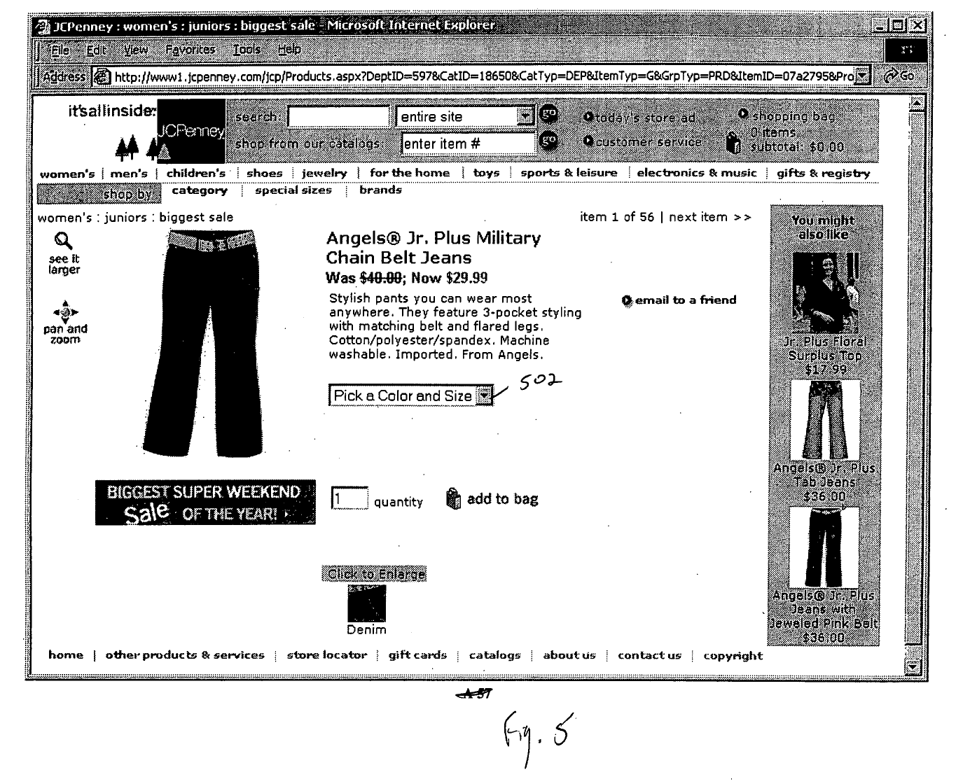

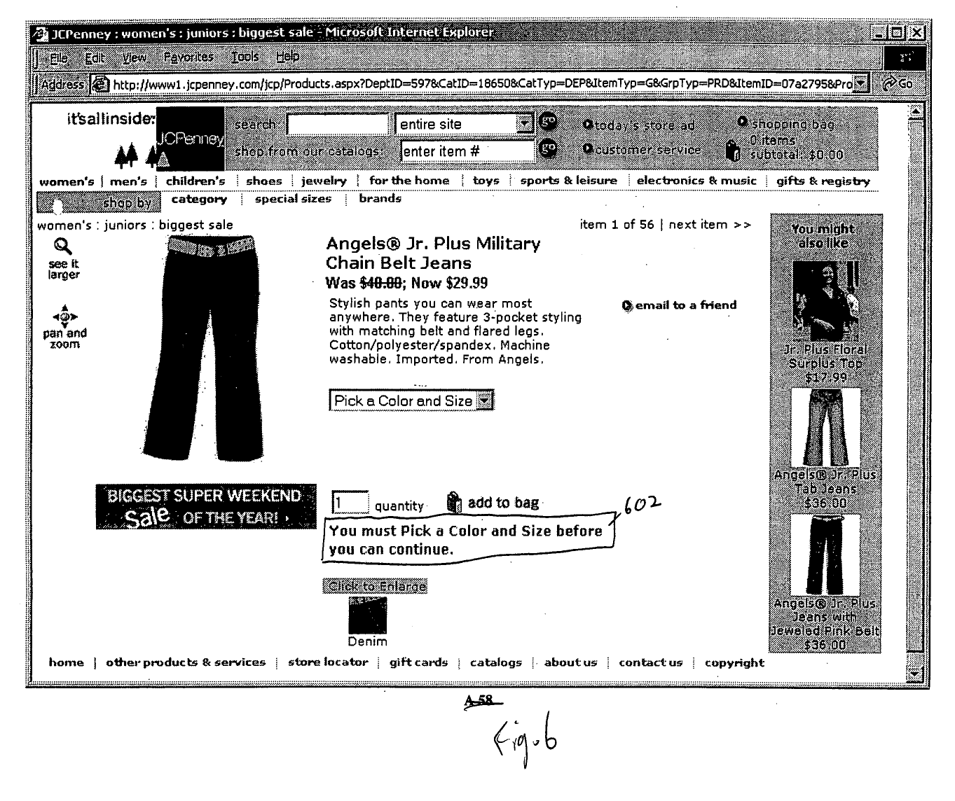

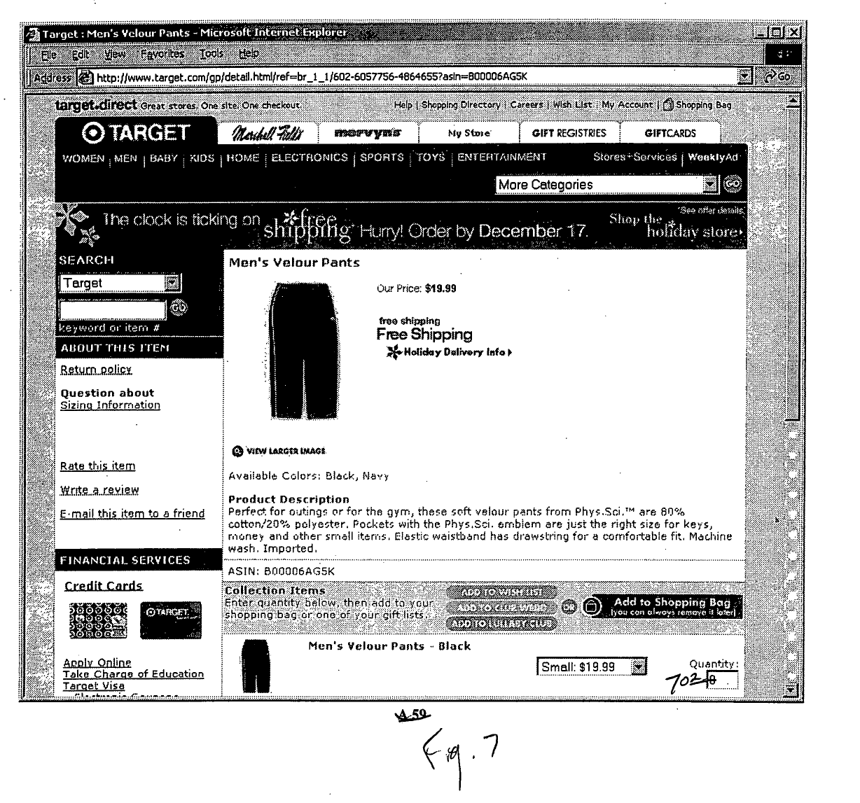

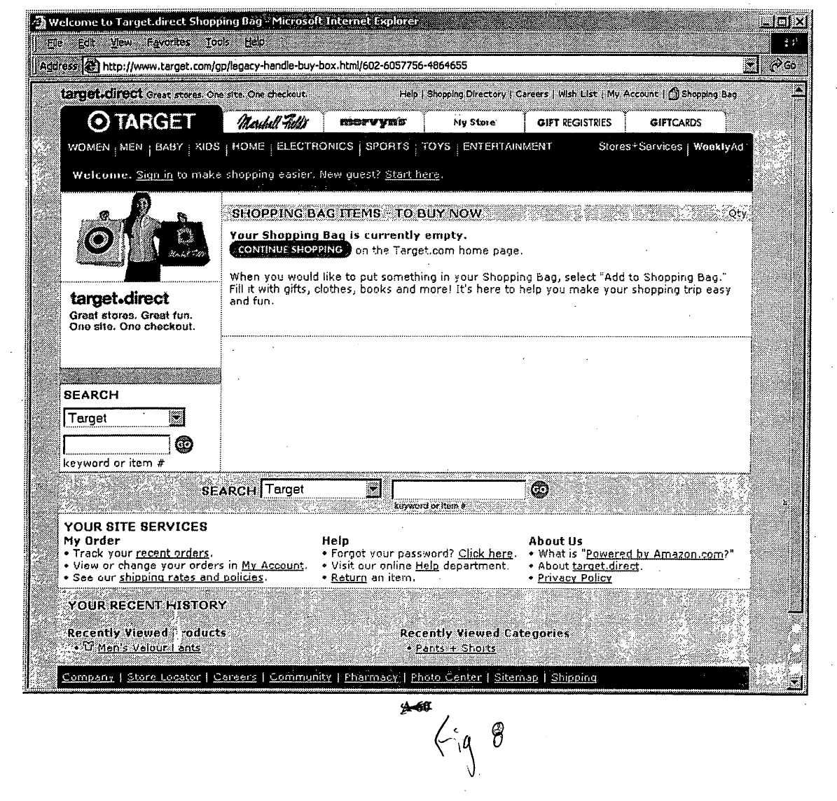

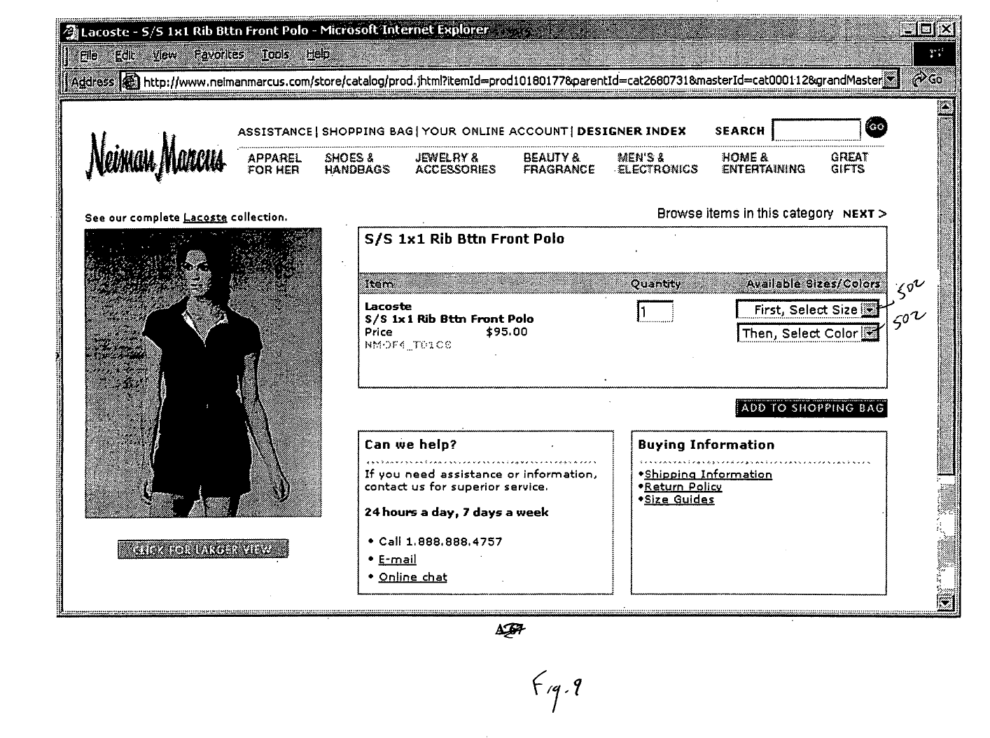

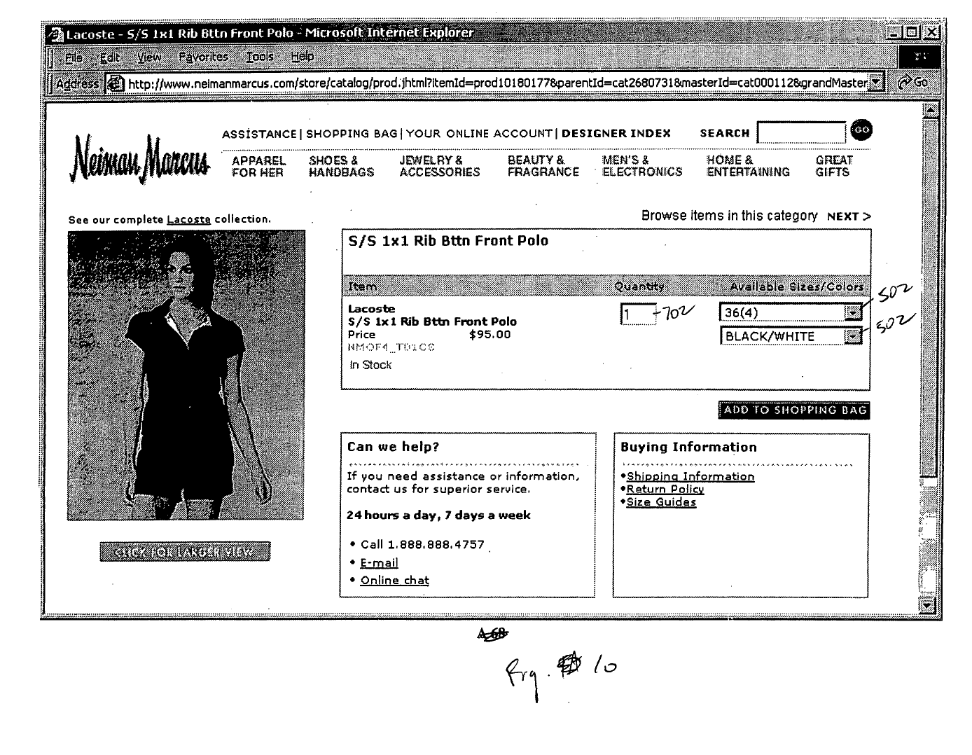

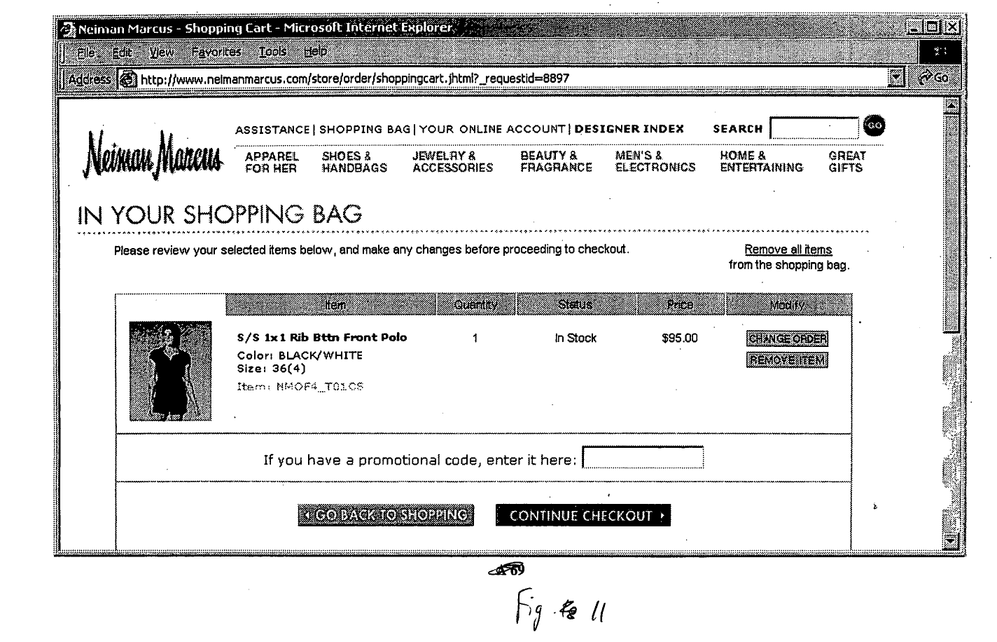

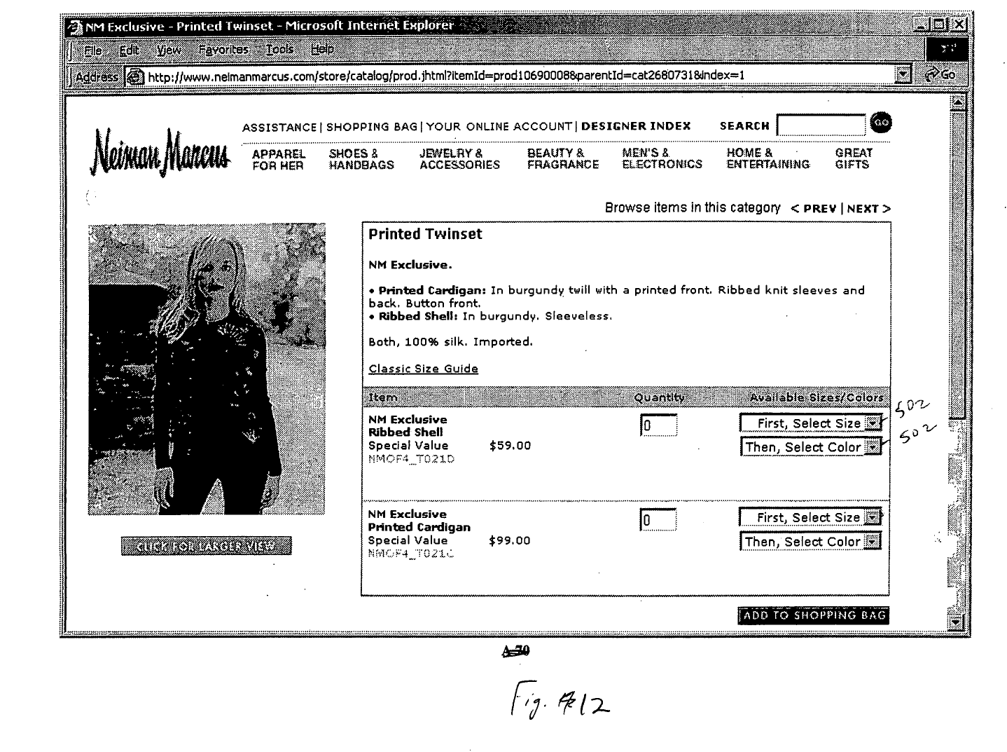

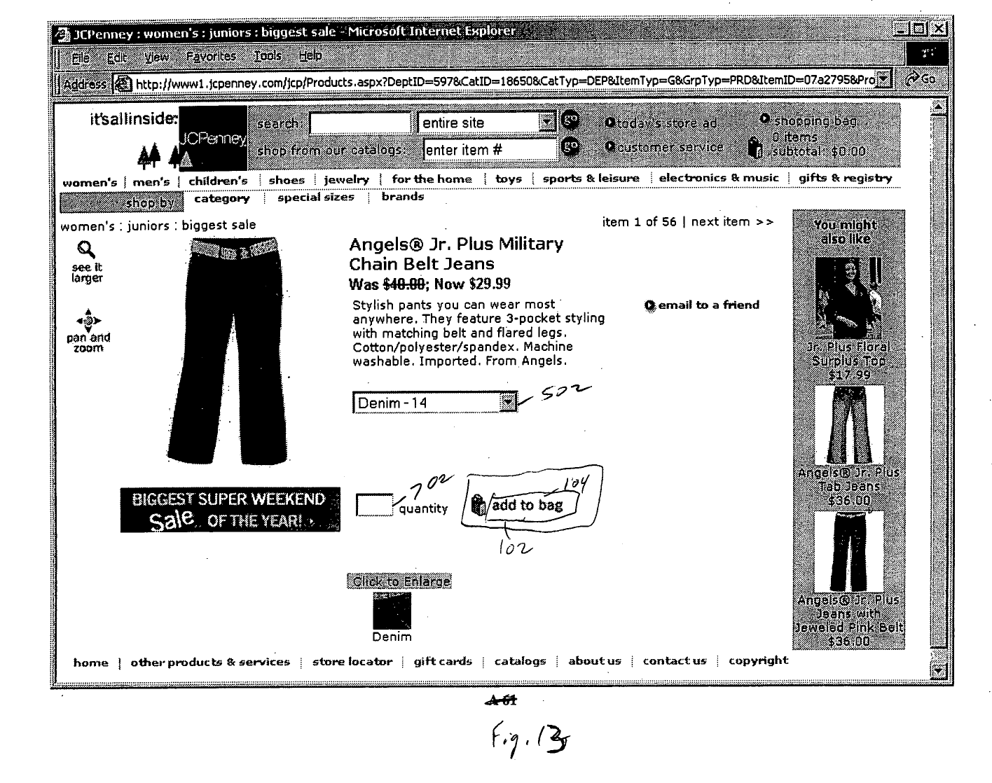

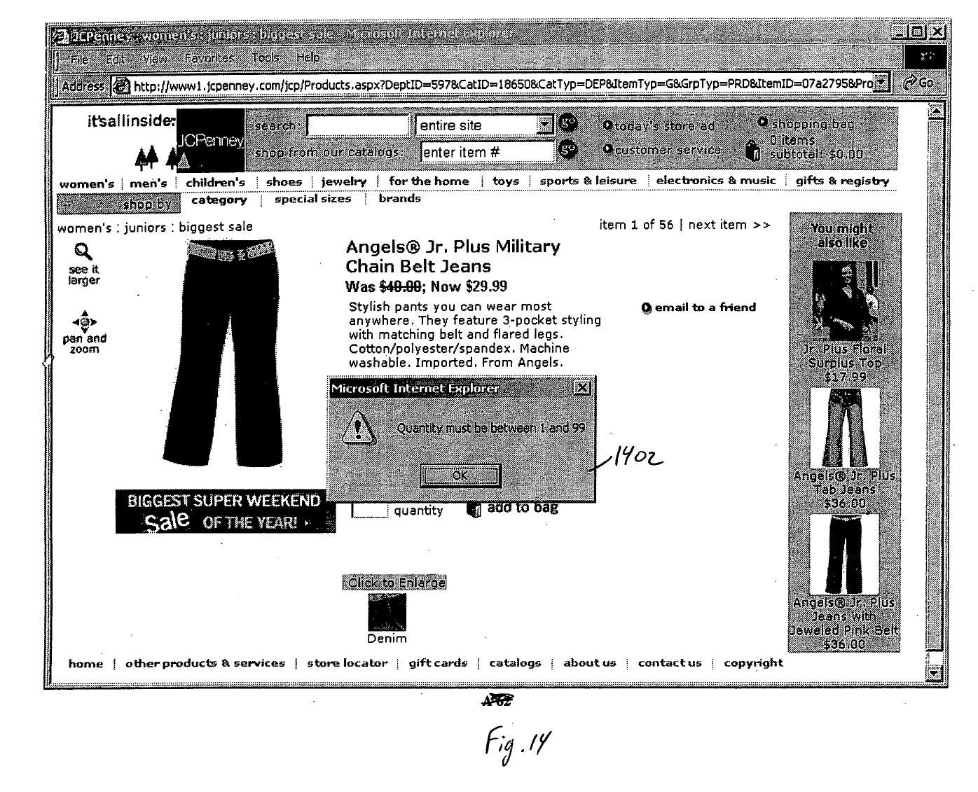

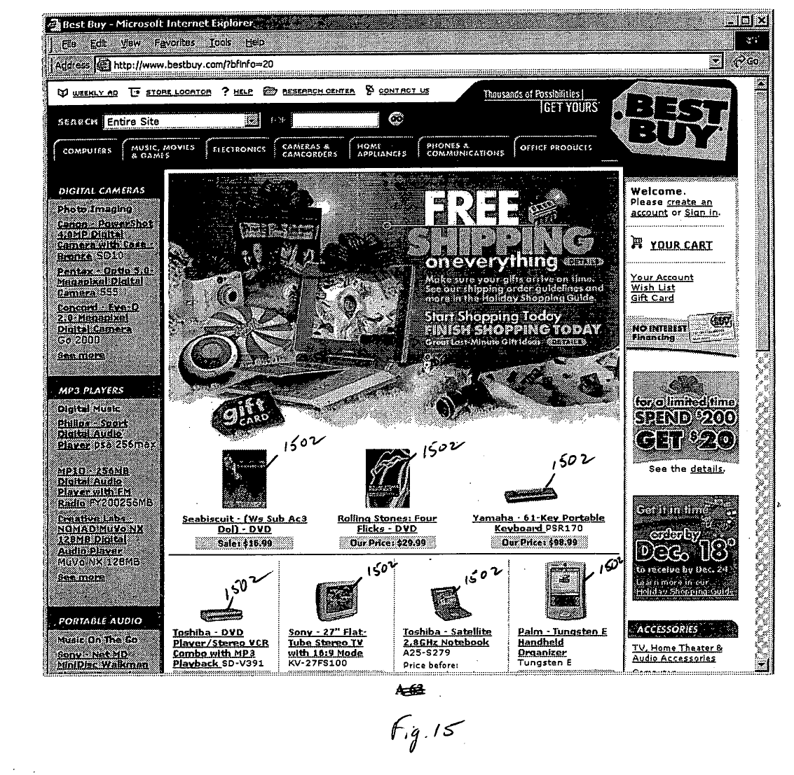

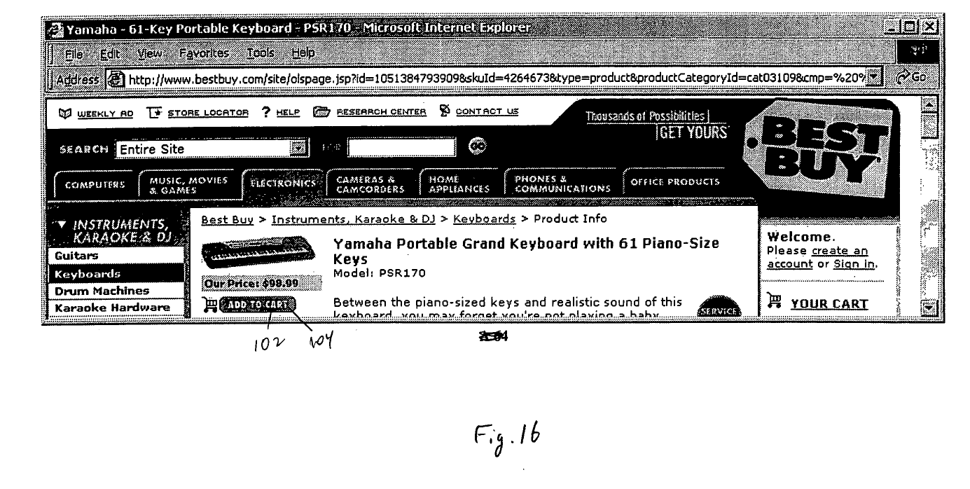

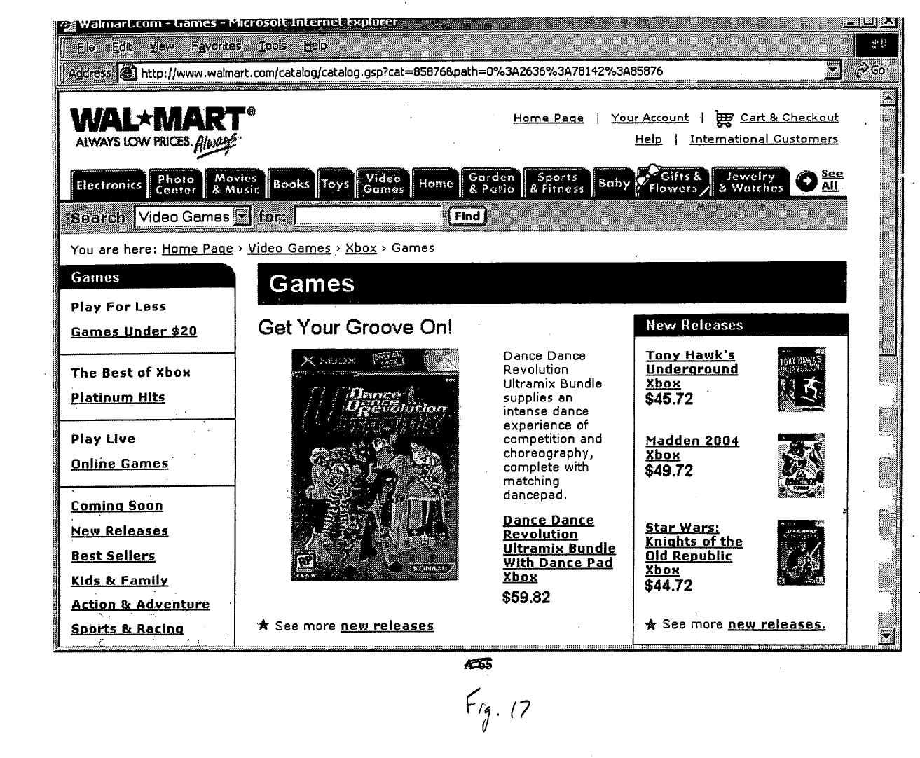

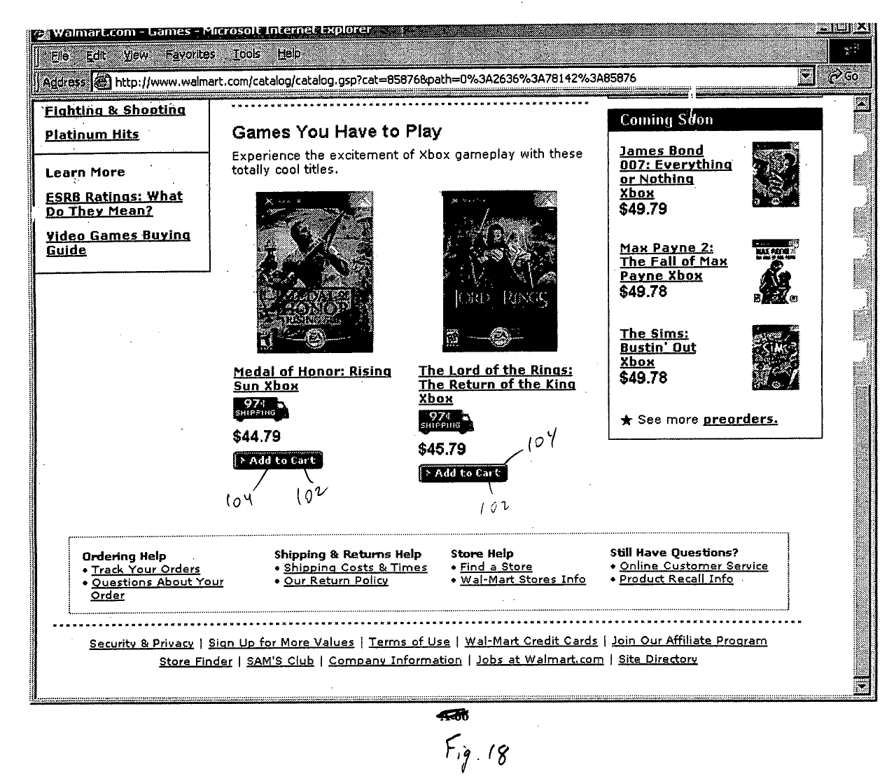

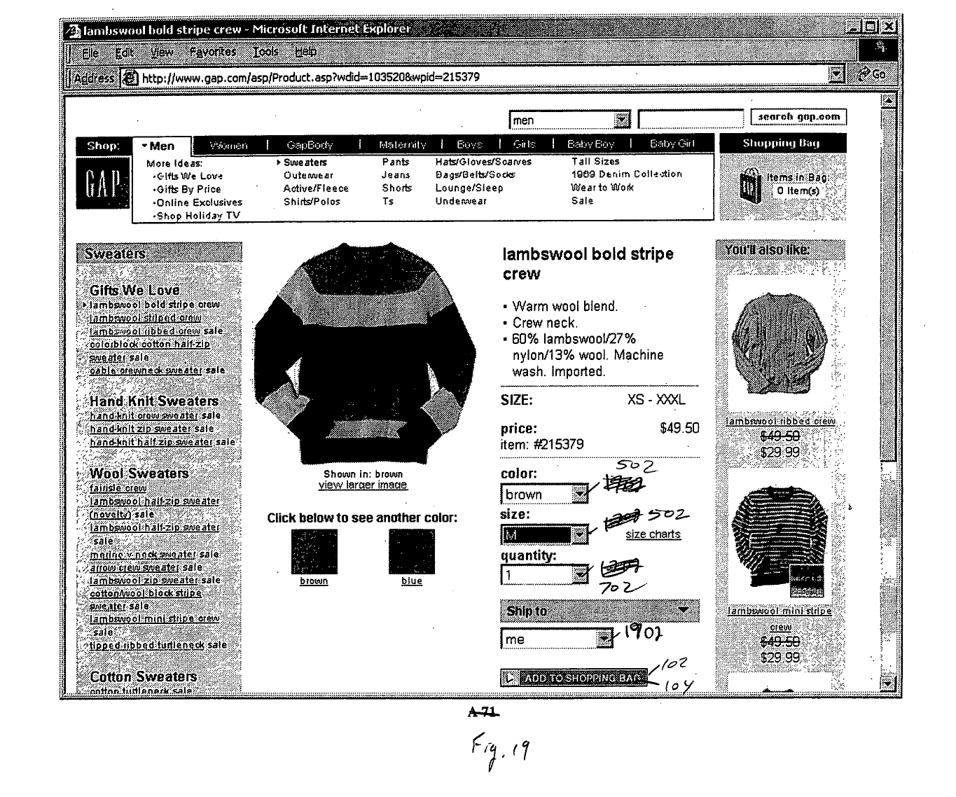

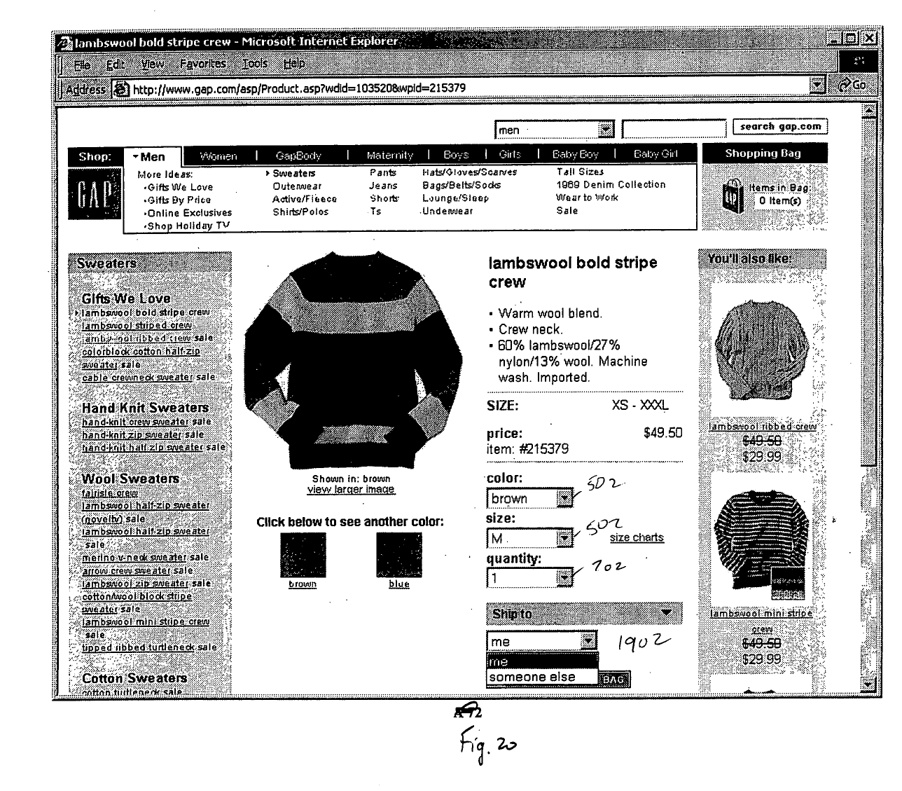

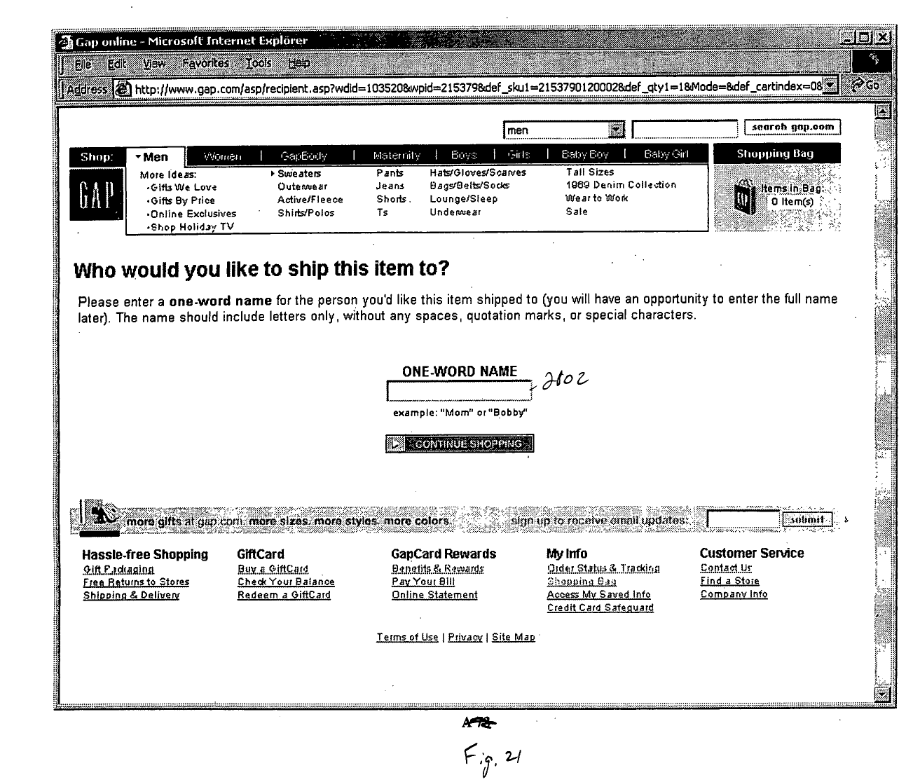

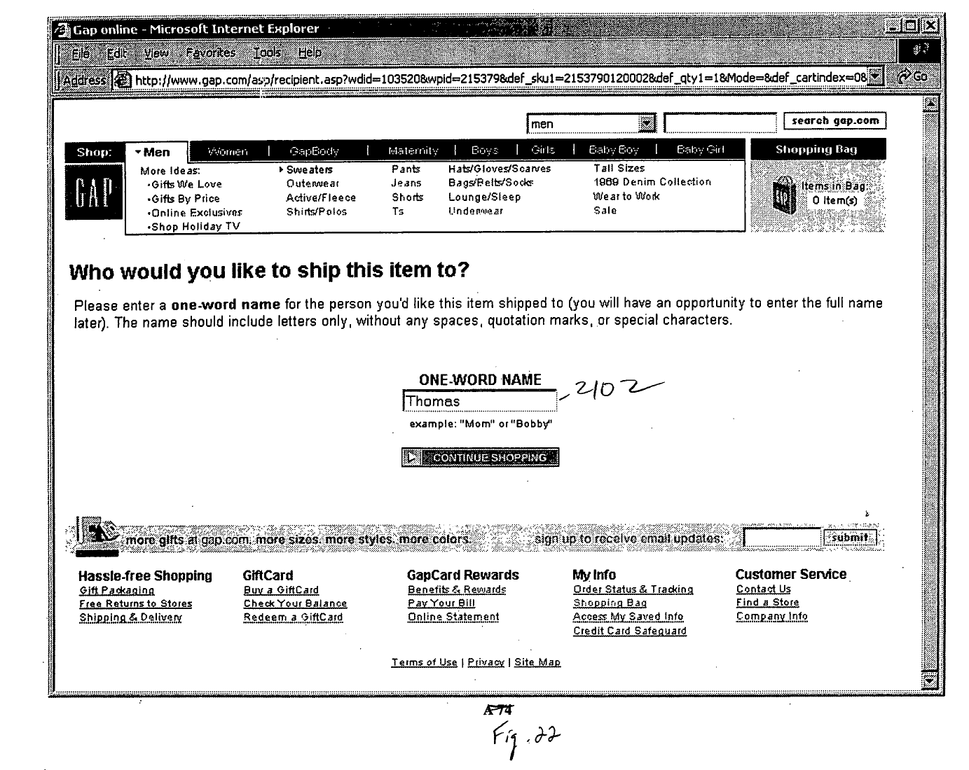

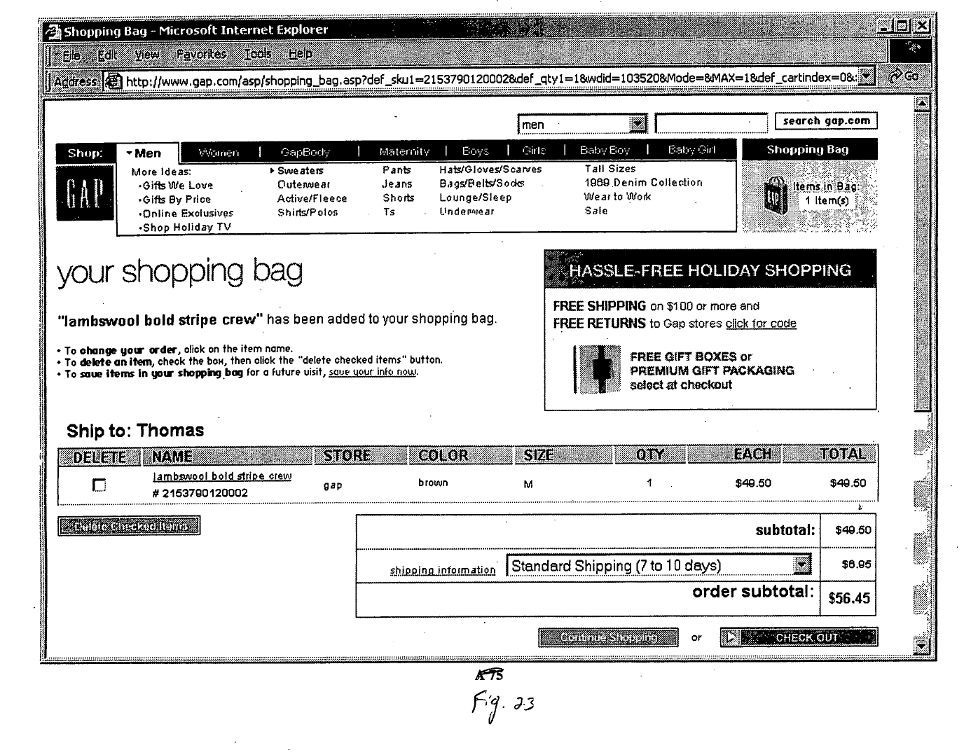

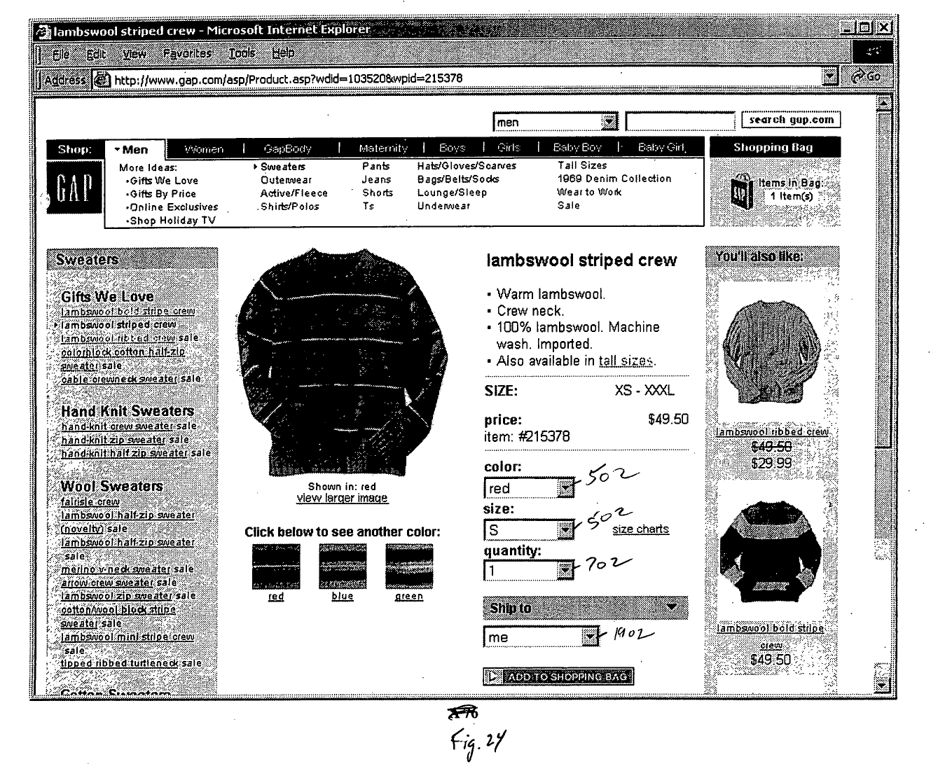

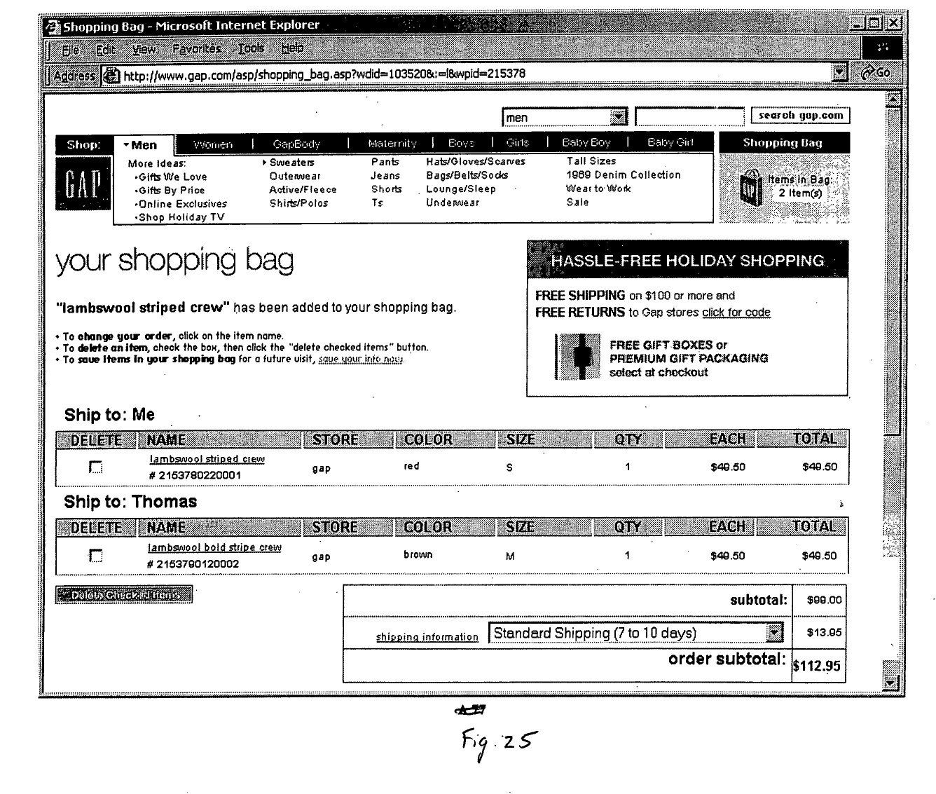

As shown in FIG. 31, shopping cart icon 3102 is depicted without accompanying instructional text 104 (FIG. 1). The example shopping cart icon 3102 shown in FIG. 31 thus requires little to no additional display space in an e-commerce web site. Shopping cart icon 3102 can appear whenever and wherever a depiction of an item for sale appears, without sacrificing valuable space that may be used, for example, to depict other items available for purchase. Formatting icon 3102 in this way, without prior art instructional text 10, reduces confusion and thereby increases the ease of use and likelihood a sale transaction will occur.

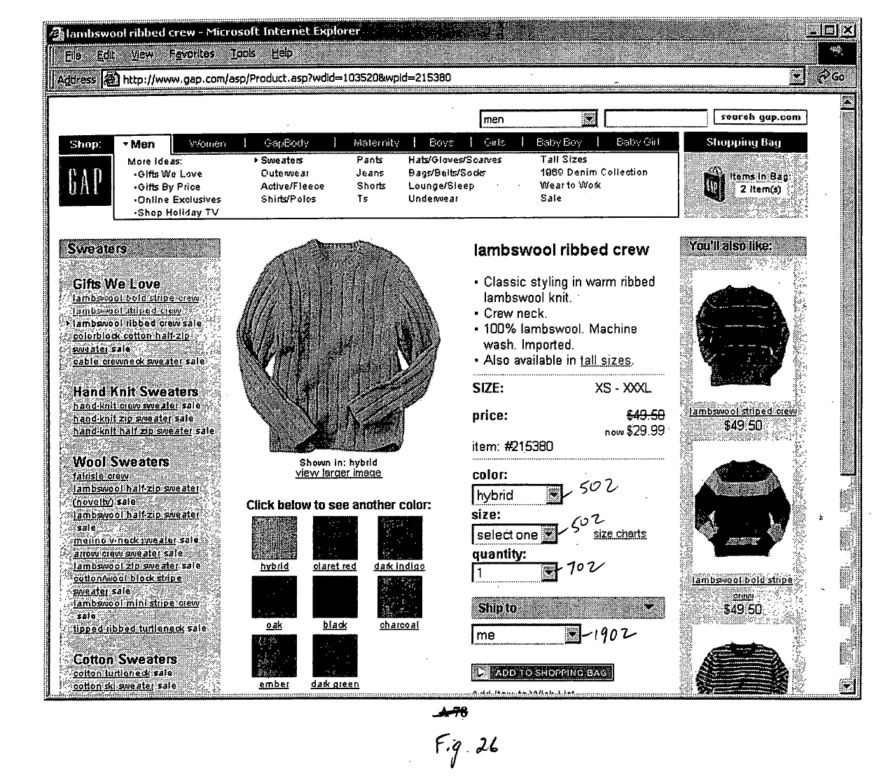

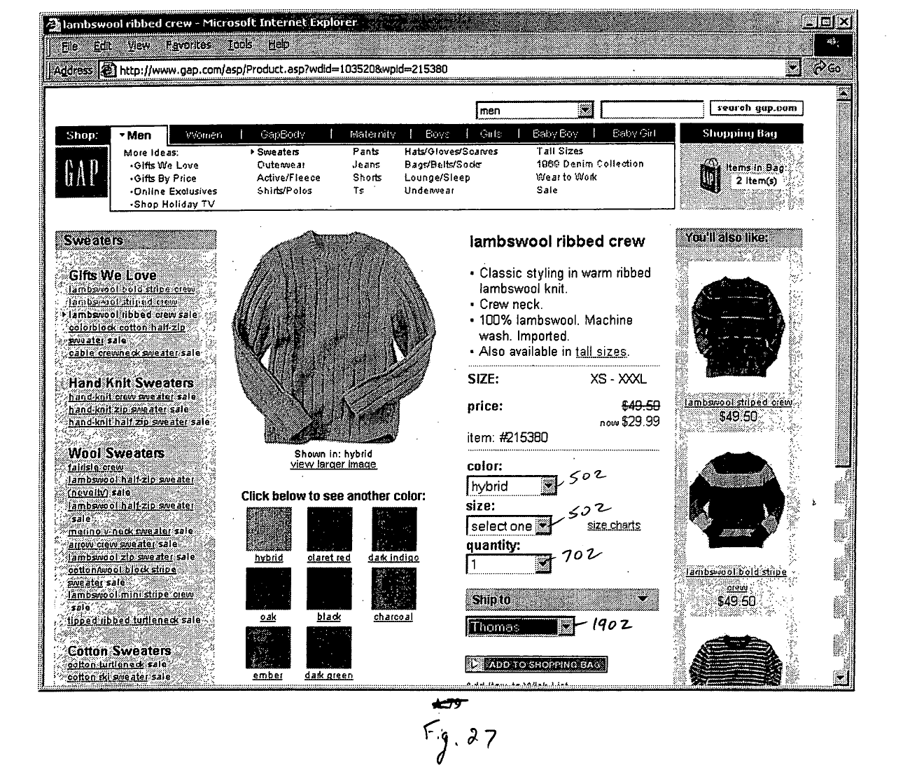

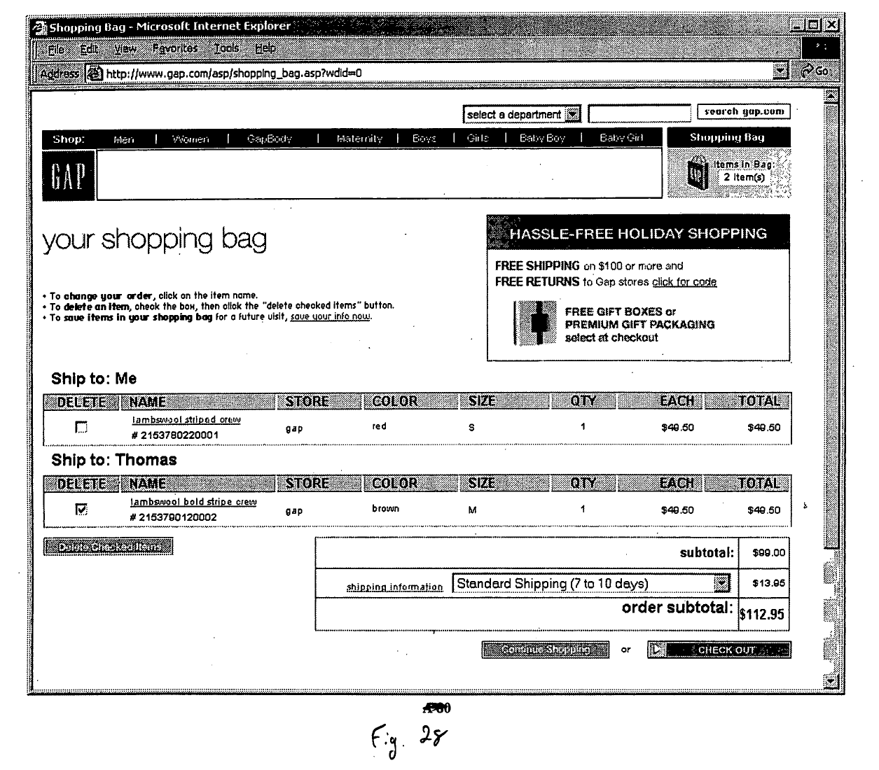

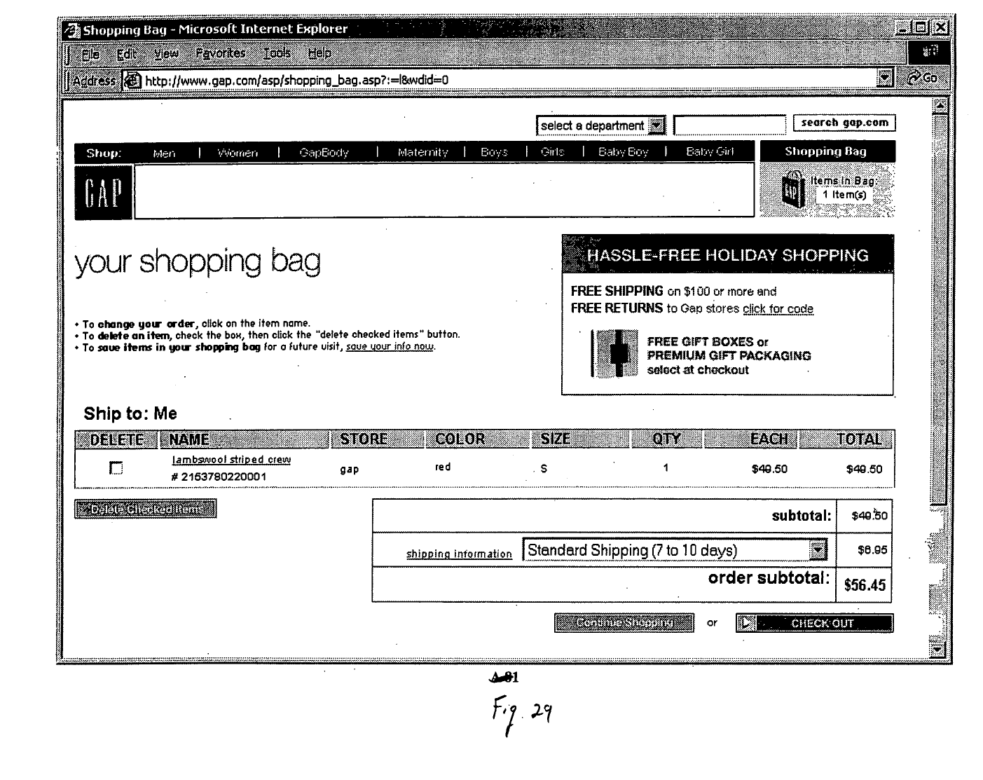

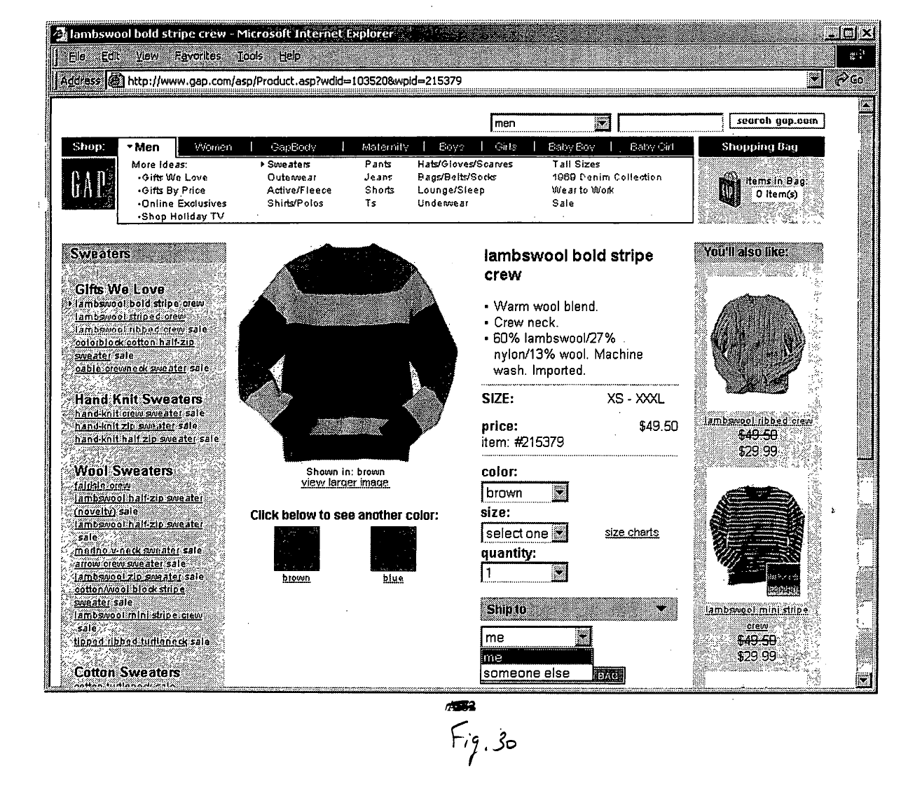

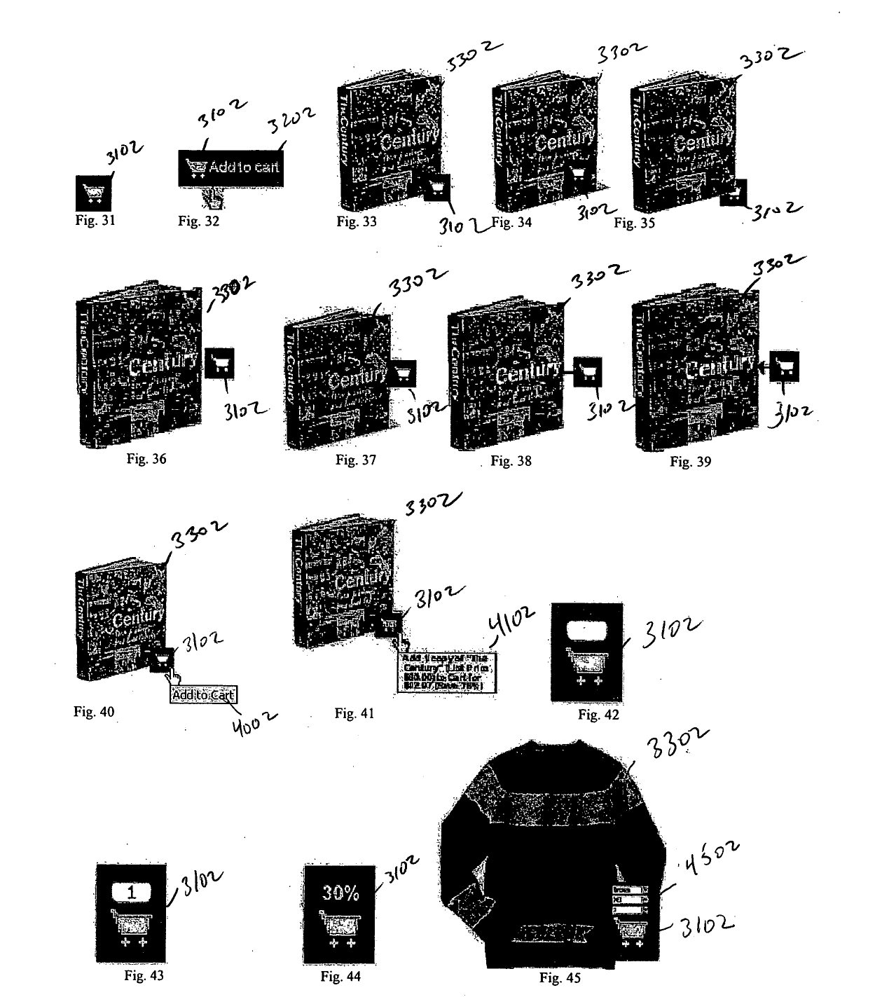

In another example embodiment of the present invention, shown in FIG. 32, shopping cart icon 3102 changes when a selector, such as a computer mouse, moves near or over the icon. In this example embodiment, instructional text 3202 (“Add to cart”) appears as part of icon 3102 when the selector appears near or over it (space). In the embodiments illustrated in FIGS. 31 and 32, shopping cart 3012 is formatted in a compact way such that the various benefits of the present invention, described herein, can be realized. Preferably, the appearance of shopping cart icon 3102 changes back to its initial form after the selector is moved away from the icon (as shown in FIG. 31).

FIGS. 33-39 illustrate example embodiments of shopping cart icon 3102 that show various positions of icon 3102 with respect to item depiction 3302. In the examples illustrated in FIGS. 33-41, item depiction 3302 refers to a book; of course, one skilled in the art will recognize that many other types of goods and services can represented by item depiction 3302. The close proximity of shopping cart icon 3102 to item depiction 3302 reduces the amount of space required for the combination of the item and the icon, thereby reducing the need for additional valuable display screen space, the likelihood that a visitor will be confused, and the likelihood a purchase transaction will be interrupted.

One skilled in the art will recognize that many benefits can be realized by the present invention. For example, since shopping cart icon 3102 is closely associated with item depiction 3302 of an item offered for sale, a visitor's confusion as to how to implement a sales transaction is reduced. Also, formatting icon 3102 without instructional text 104 allows the icon to be placed in very close proximity to an item depiction. Thus, a visitor to an e-commerce web site has less (or no) distance to move the mouse pointer when the shopping cart icon 3102 is positioned close to item depiction 3302, thereby increasing ease of use and the likelihood of a completed sales transaction.

Also, as shown in the example embodiments of the present invention in FIGS. 31-45, the association between item depiction 3302 and shopping cart icon 3102 is reinforced by placing at least one on a background field of a distinctive color or pattern. For example, the association shopping car icon 3102 may be reinforced by placing it within a distinctive border or box.

In the various embodiments shown in FIGS. 33-39, icon 3102 appears to partially overlap item depiction 3302 (FIG. 33), to be partially overlapped by item depiction 3302 (FIG. 35), be completely encompassed by item depiction 3302 (FIG. 34), to be immediately adjacent to item depiction 3302 (FIG. 37), and/or very close, without physically touching item depiction 3302 (FIG. 36). Alternatively, shopping cart icon 3102 connects to item depiction 3302 via a physical indicator (FIG. 38), or relates to item depiction 3302 using an arrow or other symbol of pointing (FIG. 39). Any similar or equivalent method of placing shopping cart icon 3102 so that it is immediately perceived as being connected or related to item depiction 3302 is provided by the present invention.

In accordance with an example embodiment of the present invention, shaping cart icon 3102 is positioned in a predetermined way with respect to item depiction 3302. The relative position of icon 3102 to depiction 3302 remains the same, notwithstanding various display screen events, such as when a visitor resizes a web browser display screen. Preferably, if a display screen changes, such as by resizing, the position of icon 3102 with respect to item depiction 3302 is unchanged.

In the example embodiment of the present invention shown in FIG. 40, flyover text 4002 appears near shopping cart icon 3102 and initially includes language, such as the phrase “add to cart” or the equivalent. In another example, embodiment of the present invention, for example, as shown in FIG. 41, flyover text 4102 that is associated with shopping cart icon 3102 is dynamic, and changes to display text according, for example, to the item that the visitor is purchasing. Alternatively, flyover text 4002 changes to flyover text 4102 to represent a record of events that occur during the on-line shopping session, such as to state whether an item has been purchased. In this way, flyover text 4102 represents an improvement over the prior art flyover text that is static and relatively uninformative.

In yet another example embodiment of the present invention, shopping cart icon 3102 is rendered in at least one of a number of distinctive colors to indicate variations, such as levels of discount, free shipping, free gift wrapping, or any other distinctive aspect of the sale offer. Optionally, flyover text 4102 includes a description of this distinctive treatment. Moreover, shopping cart icon 3102 can be rendered to include additional symbols (such as a dollar sign or other unit of currently; a representation of a gift box or gift card, etc.) to indicate distinctive aspects of the sale offer. Further, flyover text 4102 can be associated with such an item that includes a description of this distinctive sales offer.

In accordance with an example embodiment of the present invention, shopping cart icon 3102 is formatted to receive input from the visitor to the e-commerce web site, such as a value representing quantity. FIG. 42 illustrates shopping cart icon 3102 formatted to receive a value representing the quantity of items desired by the visitor. FIG. 43 shows another example embodiment, wherein shopping cart icon 3102 is formatted to supply a default value of 1.

In the example embodiments of the present invention shown in FIGS. 42 and 43, in which shopping cart icon 3102 is formatted to receive a value for quantity, even if that value is missing (because the user has accidentally deletes it, for example), the item is still placed in the shopping cart, preferably with the quantity set to 1, when the user selects the icon. FIG. 44 illustrates another example embodiment of the present invention in which a percentage value, e.g., 30%, is displayed in shopping cart icon 3102.

FIG. 45 illustrates an example embodiment of the present invention in which shopping cart icon 3102 receives input regarding item specifications other than quantity. Preferably, even if an item has one or more specifications which must be provided by the visitor in order to complete the purchase transaction, and even if the visitor fails to fully provide each required detail, the item is placed in an e-commerce shopping cart when shopping cart icon 3102 is selected. In such a case, a data entry display screen 4502, such as shown in FIG. 45, is provided for the visitor to submit item detail information that may be required for completing a sales transaction.

Thus, even if a price of an item cannot be determined until one or more options are specified by the visitor (for example, because an item in the extra large size costs more than in the smaller sizes), the item is still added to the shopping cart with those options specifiable in the shopping cart. For example, if the user has not specified all the variations necessary to fully specify the item, a window is displayed in which those specifications can be completed, rather than displaying an error message.

In an example embodiment of the present invention, shopping cart icon 3102 specifies the minimum, maximum, median, likeliest, or average price as an estimate. These estimates are preferably displayed in a distinctive way.

In case an item offered for sale is only available in one option (such as one particular color), the selection mechanism that is otherwise available for that option preferably is not displayed for that item. Thus, only those graphic screen controls, such as check boxes, drop-down lists, text boxes, or the like, for options/specifications that are available for a particular item, are displayed. In an example embodiment of the present invention, an indication is provided that only the optimal control(s) displayed are available.

Many operating systems, such as the MICROSOFT WINDOWS family of operating systems, enable a user to choose a preferred language in which the computer is meant to be operated, including, for example, the language of displayed text. Preferably, the an e-commerce web site in accordance with the present invention automatically accesses and interprets the setting of the user's language and selects the appropriate text in that language to display, including flyover text 3702 and language displayed in shopping cart icon 3102. Preferably, the user can choose a different language.

In addition to selecting a language, many operating systems (such as the MICROSOFT WINDOWS family of operating systems), enable the user to choose a preferred currency in which monetary amounts are to be displayed. Preferably, an e-commerce site in accordance with the present invention automatically accesses and interprets a user's settings, including default currency preferences and displays all prices accordingly.

In an example embodiment of the present invention, the web site uses a currency conversion system to convert all prices automatically. Optionally but preferably, the user can choose another currency. In an example embodiment of the present invention, databases containing prices for one or more products is provided for in one or more currencies. Preferably, the databases are updated regularly, such as twice daily, to provide accurate and up-to-date foreign exchange rates. If the web site has the price in the user's currency for the selected product, the web site uses the price in its database rather than the value obtained using a separate currency conversion system.

In accordance with an example embodiment of the present invention, user preferences, including, for example, the shopping cart contents and other such lists defined are stored in a database or information processor that is remote or from the user's workstation. Accordingly, when the user logs on to the same e-commerce web site from another computing device, the display is in accordance with the user's preferences.

In an alternative embodiment of the present invention, the user's preferences, including the shopping cart contents and item specifications provided by the visitor, are stored on the user's local machine, typically, as a Internet “cookie,” so that, when the user accesses to an e-commerce web site using the same workstation as that in a previous e-commerce web site session, the user's preferences are displayed even before the user has identified himself or herself to the web site, for example, by logging on.

In accordance with an example embodiment of the present invention, an e-commerce site identifies the user's preferred language, currency and other available system setting and determines the country in which the user is likely to be resident. Having done so, the present invention uses this information to determine details such as shipping options, the costs of each such option, applicable duties or other import charges and/or restrictions. Further, the present invention preferably employs user-defined preferences at a computing device's operating system level in order to identify and display relevant information to the visitor. For example, if a visitor is likely to be living in a country in which a particular television is not likely to operate properly because of signal incompatibilities, a message is displayed to that effect.

It is envisioned herein that, on those web sites that enable a visitor to complete a purchase by selecting a single icon, thereby bypassing an e-shopping cart completely (via the so-called “one-click” method), the functionality described herein and provided by the present invention may be incorporated.

Moreover, those sites that employ features provided by the present invention and that provide online auctions in which the user places a bid on an item rather than putting in a shopping cart or other list of items or purchasing it, all the functionality described herein is applied. For example, a separate icon is created for placing a bid, and the icon is depicted on or near the depiction of the item itself, as depicted in FIG. 31 through 40.

In accordance with an example embodiment of the present invention, a visitor to an e-commerce web site can create multiple e-shopping carts which can be uniquely identified, for example with a name. Moreover, the visitor can create multiple, named shopping carts during any stage in the shopping process, for example, by selecting an appropriate hyperlink or icon, or by selecting on an appropriate icon on the e-shopping cart display itself. Preferably, multiple shopping carts can be displayed and accessed in a variety of ways: In multiple windows; in multiple frames within a single window; as successive lists in a single window; as multiple tabs within a single window; and by selecting a shopping cart within a single window, for example, by using selection methods known to those skilled in the art, such as buttons, drop down selection lists, check boxes or the like.

In accordance with an example embodiment of the present invention, information about an individual associated with each shopping cart is stored in a database. Examples of the information include sex, age, sizes, shipping address preferences, gift wrap preferences, etc. This information is available whenever the user accesses the web site, even if there are no items in any shopping cart list at a particular time.

Further, and in accordance with an example embodiment of the present invention, the visitor can specify shipping preferences for each individual associated with a shopping cart according to a variety criteria. These criteria include, for example, speed, price, reliability (guarantee of delivery by specified date or within specified number of days), preference of carrier, and, if the carrier offers a variety of services, the shipping service.

Preferably, the visitor adds, deletes, renames, and changes the characteristics of the named shopping cart in accordance with an example embodiment of the present invention. Further, the present invention enables visitors to move items from one named shopping cart to another named shopping cart. Preferably, the present invention identifies the last e-shopping cart which the user has placed an item, and, accordingly, places the next selected item into that same shopping cart. Furthermore, if an item is inappropriate for a particular shopping cart (for example, if the item is for women but the last shopping cart was for a man), the item is placed in the most recently used appropriate shopping cart. In this way, the present invention identifies potential inconsistencies in a visitor's on-line purchasing can be identified prior to completion of an unintentional sales transaction

In another example embodiment of the present invention, if more than one shopping cart has been defined, the “place in cart” icon displays a selectable mechanism by which the user can choose one of a plurality of shopping carts. If a visitor has not specified the variations applicable to an item for sale, the e-commerce site applies the appropriate variation according to the characteristics of the individual associated with that e-shopping cart. For example, for a piece of apparel, the present invention selects the size appropriate for the individual associated with that shopping cart.

As noted above, in an example embodiment of the present invention, the most recent setting chosen by a visitor that represents a characteristic (such as size, color preference, etc.) associated with an item is stored. If the specifications applicable to one or more items have not been provided when the visitor displays the e-shopping cart, the depiction of such items is distinctive. For example, the size of a shift in an e-shopping cart has not been specified by the visitor, so that the color of the typeface used to represent the item in the e-shopping cart is different from other typefaces depicting items.

Moreover, if the specifications applicable to one or more items have not been provided when the visitor displays the e-shopping cart, the user can provide the missing item specifications via icon 3102, for example, as displayed in FIGS. 42-45. Alternatively, particular item specifications can be entered in a separate data entry display screen, for example, provided in the e-commerce web site.

When a visitor has placed items in separate shopping carts, the present invention preferably calculates the shipping costs, gift-wrapping charge, etc., separately for each shopping cart. Further, the functionality described herein can be applied to collections of items, such as gift registries, wish lists, etc. A separate icon (for example, a small depiction of a bride and groom) is preferably created for each such list, and each such icon is depicted on or near the depiction of the item itself, as described above and in accordance with the present invention.

When the user has finished selecting items for purchase, if multiple shopping carts have been created, the present invention preferably prompts the user to identify which, if any, of the shopping carts are to be saved for the next time the user visits the site.

In accordance with an example embodiment of the present invention, classes of web pages and their behaviors are defined and established. Each web page defined on the web site is preferably designated as belonging to a class. Each class preferably has a corresponding set of instructions. Example instructions associated with a class of web sites include: never close as a result of closing a web page from the same site; always remain open as long as any web page from the same site is open (this is useful for the main web page and for the shopping cart web page or web pages); interpret the command to close as the command to “minimize”; always allow only one instance, even if attempted from a second browser session or other means of navigation (this is particularly useful for a web page displaying an individual shopping cart or other list, which can otherwise become out-of-synch if multiple copies are open at different times); allow multiple instances only if each instance is distinguishable (as with named shopping carts); skip when the visitor invokes the “return to shopping” icon (this is particularly useful for a page that displays only a single item that has just been placed in the shopping cart.; always close when the main web page is closed (this is particularly useful for pages that show, for example, size charts, currency conversions, etc.); and always close when the web page from which the current page was invoked is closed.

For those e-commerce web sites which do not display the shopping cart as a portion of a shopping page, the following behaviors are optional but preferable:

when the visitor adds an item to an e-shopping cart for the first time, the present invention automatically opens the e-shopping cart in a new web browser display screen. A message appears on the original display explaining this. Preferably, the focus remains in the original display screen and does not switch to the newly opened web browser display screen.

Moreover, the process of adding an item to the shopping cart never replaces the window the user is viewing in the current with the shopping cart. When the visitor adds another item to the shopping cart, the window displaying the e-shopping cart is refreshed to display the additional item or items and to recalculate the estimated costs and total price.

If a browser window with the shopping cart is already open, invoking the option for the shopping cart does not open a new window, but brings the already-open window into the foreground and makes it the current focus. (Preferably, this occurs even if the user uses the Browser's context menu to “open link” or “open link in new window”.)

Thus, the present invention provides benefits over prior art e-commerce web sites that translate into an increased number of completed sales transactions. It is preferred that the present invention not be limited by the specific disclosure herein.

1. A user interface for selecting at least one good or service for purchase in an e-commerce site, the interface comprising:
a first electronic representation of a good or service offered for sale on the e-commerce site;
an electronic shopping cart adapted to contain at least a second representation of the good or service; and
an icon associated with the electronic representation that, when selected, causes the second representation of the at least one good or service to be placed in an electronic shopping cart, wherein the icon includes no text and wherein the icon is placed in a predetermined position relative to the first representation.

2. The user interface of claim 1, wherein the icon completely overlaps with the first representation.

3. The user interface of claim 1, wherein the icon is placed adjacent to the first representation of the good or service.

4. The user interface of claim 1, wherein the icon intersects a portion of the first representation of the good or service.

5. The user interface of claim 1, wherein the icon is formatted to represent a shopping cart.

6. The user interface of claim 1, wherein the icon includes a representation of the good or service.

7. The user of interface of claim 6, wherein the icon changes to include a quantity of the good or service requested for purchase when a selector is placed at least near the icon.

8. The user interface of claim 7, wherein the changed icon includes information regarding details of the good or service.

9. The user interface of claim 1, further comprising flyover text associated with the icon.

10. The user interface of claim 9, wherein the flyover text includes a description of the good or service.

11. The user interface of claim 9, wherein the flyover text changes upon occurrence of an event.

12. The user interface of claim 11, wherein the event is a purchase of a good or service.

13. The user interface of claim 1, wherein the icon includes a data entry module.

14. The user interface of claim 13, wherein the data entry module is adapted to receive information from a user of the user interface.

15. The user interface of claim 14, wherein the information includes user preferences.

16. The user interface of claim 1, further comprising a preference control that receives preference information from a user of the user interface.

17. The user interface of claim 16, wherein the preference control is formatted as at least one a drop-down list, a checkbox, a textbox, a radio button, and a listbox.

18. The user interface of claim 16, wherein the preference information includes at least one of color, size, shape, style, quantity, delivery method, delivery location, recipient, and format.

19. The user interface of claim 1, further comprising a preference storage module that receives preference information.

20. The user interface of claim 19, wherein the preference storage module stores the preference information, and wherein the storage module applies the preference information during a future purchasing session.

21. The user interface of claim 1, further comprising a currency converter, wherein foreign exchange rates are utilized to calculate costs associated with the good or service.

22. The user interface of claim 21, wherein payment can be received at least one of at least two different currencies.

23. The user interface of claim 1, further comprising a user settings module that identifies and applies settings associated in an operating system.

24. The user interface of claim 1, further comprising an estimator that identifies a minimum, maximum, median, or average price to estimate a cost associated with the good or service.

25. The user interface of claim 1, wherein the icon is colored to represent variations.

26. The user interface of claim 25, wherein the variations include at least one of a discount, shipping selection, or gift wrapping selection.

27. The user interface of claim 1, further comprising quantity module that sets the value of quantity for the good or service to equal 1.

28. The user interface of claim 1, wherein a display of contents of the electronic shopping cart is refreshed upon receipt of selections from a user.

29. The user interface of claim 1, wherein the e-commerce site is an provides an on-line auction.

30. The user interface of claim 1, further comprising a shipping selection module that receives user selections regarding shipping methods.

31. The user interface of claim 30, wherein the shipping selection module associates at least one shipping method with at least two respective electronic shopping carts.

32. The user interface of claim 31, wherein the shipping selection module further stores the at least one shipping method for future electronic shopping carts.

33. The user interface of claim 1, further comprising an association module that associates an electronic shopping cart with a user.

34. The user interface of claim 33, wherein the association module saves the contents of the electronic shopping cart for future purchases.

35. The user interface of claim 1, further comprising a e-commerce site class module, wherein an e-commerce site is associated with a particular class.

36. The user interface of claim 35, wherein the e-commerce site executes an instruction according to the class associated therewith.

37. The user interface of claim 1, wherein the electronic shopping cart is displayed in a separate web browser display screen.

38. The user interface of claim 1, wherein the relative position of the icon and the first representation remains constant.

39. A method for providing an e-commerce site, the method comprising:
electronically representing a good or service offered for sale on the e-commerce Internet web site;
electronically providing an electronic shopping cart that contains a description of goods or services offered for sale on the e-commerce Internet web site; and
providing an icon associated with the at least one representation that, when selected, causes a representation of the at least one good or service to be placed in an electronic shopping cart, wherein the icon includes no text and wherein the user interface comprises the icon in a predetermined position relative to the representation of the good or service.
